(19) United States
(12) Patent Application Publication
(10) Pub. No.: US 2016/0275148 A1
(43) Pub. Date: Sep. 22, 2016

(54) DATABASE QUERY METHOD AND DEVICE

(71) Applicant: Huawei Technologies Co., Ltd., Shenzhen (CN)

(72) Inventor: Nan Jiang, Reading (GB)

(21) Appl. No.: 15/074,599

(22) Filed: Mar. 18, 2016

(30) Foreign Application Priority Data
Mar. 20, 2015 (CN) 201510123021.7

(51) Int. Cl. G06F 17/30

(52) U.S. Cl. CPC G06F 17/30525; G06F 17/3043

(57) ABSTRACT

The method includes: acquiring a to-be-queried statement, where the to-be-queried statement is a natural language query statement; dividing the to-be-queried statement according to a preset word stock to obtain N words; determining, from a preset database, at least one candidate database entity of a first word, where the first word is any word in the N words, and separately annotating a label on each word in the N words to obtain annotation information corresponding to the to-be-queried statement; generating K query conditions according to the annotation information, where each query condition in the K query conditions includes a second word, an operator, and a third word; generating a query target according to the annotation information, where the query target includes a database entity of at least one word in the N words; and performing query according to the K query conditions and the query target to obtain a query result.

### CROSS-REFERENCE TO RELATED APPLICATION

This application claims priority to Chinese Patent Application No. 201510123021.7, filed on Mar. 20, 2015, which is hereby incorporated by reference in its entirety.

### TECHNICAL FIELD

The present invention relates to the communications field, and in particular, to a database query method and device.

### BACKGROUND

For conventional database query, currently, a skilled person still needs to deeply understand internal structure information of a database, and constructs a proper structured query language (SQL) query statement. If a non-skilled person does not have specialized knowledge about a database, it is relatively difficult to perform a database operation. As an Internet search engine technology continuously develops, people are gradually accustomed to entering natural language in a search box to search for a result, and also expect to query a database by using the natural language.

Because a common user does not learn a structure and a database field name/value in a database, and omits context information when describing a query request, many problems exist in the prior art. For example, a description in a user request cannot completely one-to-one correspond to the database field name/value. For SQL, if a described request does not correspond to the database field name/value, a result probably cannot be found. The user request may include ambiguous information, that is, one or more words included in a user query statement may include more than one database object (table and field), so that a query result cannot be obtained and user experience is poor.

Therefore, a technology is expected to be provided, so that a database can be queried according to a user request.

### SUMMARY

Embodiments of the present invention provide a database query method and device. According to the method, a database can be queried according to a user request, which improves user experience.

According to a first aspect, a database query method is provided, where the method includes: acquiring a to-be-queried statement, where the to-be-queried statement is a natural language query statement; dividing the to-be-queried statement according to a preset word stock to obtain N words, where N is an integer greater than or equal to 1; determining, from a preset database, at least one candidate database entity of a first word, where the first word is any word in the N words; separately annotating a label on each word in the N words to obtain annotation information corresponding to the to-be-queried statement, where the annotation information includes the N words and a label one-to-one corresponding to each word in the N words, a label one-to-one corresponding to the first word is used to indicate a data type of the first word, and the label of the first word includes an attribute name or an attribute value; generating K query conditions according to the annotation information, where each query condition in the K query conditions includes a second word, an operator, and a third word, the operator indicates a relationship between the second word and the third word, a label of the second word is an attribute name, a label of the third word is an attribute value, and K is an integer greater than or equal to 1 and less than N; generating a query target according to the annotation information, where the query target includes a database entity of at least one word in the N words, a label of the at least one word is an attribute name, and a database entity of each word in the at least one word is one of at least one candidate database entity of each word; and performing query according to the K query conditions and the query target to obtain a query result.

With reference to the first aspect, in a first possible implementation manner, the dividing the to-be-queried statement according to a preset word stock to obtain N words includes: dividing the to-be-queried statement according to the preset word stock to obtain N initial words; and standardizing the N initial words according to a preset rule to obtain the N words.

With reference to the first aspect or the first possible implementation manner, in a second possible implementation manner, the determining, from a preset database, at least one candidate database entity of a first word includes: determining, from the preset database, n initial candidate database entities of the first word, where n is an integer greater than or equal to 1; and when n is greater than 1, determining relevancy between each initial candidate database entity in the n initial candidate database entities and the first word, and determining an initial candidate database entity, relevancy between which and the first word is greater than a preset threshold, in the n initial candidate database entities as the at least one candidate database entity of the first word; or when n is equal to 1, determining the n initial candidate database entities of the first word as the at least one candidate database entity of the first word.

With reference to the second possible implementation manner, in a third possible implementation manner, the determining relevancy between each initial candidate database entity in the n initial candidate database entities and the first word includes: determining the relevancy between each initial candidate database entity in the n initial candidate database entities and the first word according to at least one of the following methods: a hit rate, vector space cosine, and an edit distance.

With reference to the first aspect and any one of the first to the third possible implementation manners, in a fourth possible implementation manner, before the generating K query conditions according to the annotation information, the method further includes: combining, according to a candidate database entity of a word in the annotation information, words successively labeled as an attribute name in the annotation information, so as to obtain a first combined word, where the first combined word is an intersection set of candidate database entities of the words successively labeled as an attribute name in the annotation information; and using the first combined word to replace the words successively labeled as an attribute name in the annotation information, so as to update the annotation information; and/or combining, according to a candidate database entity of a word in the annotation information, words successively labeled as an attribute value in the annotation information, so as to obtain a second combined word, where the second combined word is an intersection set of candidate database entities of the words successively labeled as an attribute value in the annotation information; and using the second combined word to replace the words successively labeled as an attribute value in the annotation information, so as to update the annotation information; where the generating K query conditions according to the annotation information includes: generating the K query conditions according to updated annotation information; and the generating a query target according to the annotation information includes: generating the query target according to the updated annotation information.

With reference to the first aspect and any one of the first to the fourth possible implementation manners, in a fifth possible implementation manner, the generating K query conditions according to the annotation information includes: generating M candidate query conditions according to the annotation information, where each candidate query condition in the M candidate query conditions includes a correspondence among a first candidate word, an operator, and a second candidate word, a label of the first candidate word is an attribute name, a label of the second candidate word is an attribute value, and M is an integer greater than or equal to K; determining a matching index between the first candidate word and the second candidate word of each candidate query condition; and determining K candidate query conditions that are in the M candidate query conditions and whose matching index is greater than a preset threshold as the K query conditions.

With reference to the fifth possible implementation manner, in a sixth possible implementation manner, the generating M candidate query conditions according to the annotation information includes: generating M initial candidate query conditions according to the annotation information; and performing disambiguation processing on the M initial candidate query conditions according to user information to obtain the M candidate query conditions, where the disambiguation processing includes: removing, according to the user information, ambiguity of an initial candidate query condition in which the ambiguity exists in the M initial candidate query conditions, and the user information includes at least one of: hardware information of a terminal device, software information of a terminal system, user data stored in a memory or a storage device of a terminal, a historical operation of a user, and setting of the user.

With the fifth or the sixth possible implementation manner, in a seventh possible implementation manner, the determining a matching index between the first candidate word and the second candidate word of each candidate query condition includes: determining the matching index according to at least one of: a pairing probability, a sequence distance, a matching degree of a database data type, and a language habit constraint of the first candidate word and the second candidate word.

With reference to the seventh possible implementation manner, in an eighth possible implementation manner, the pairing probability is determined by an intersection set of a database entity corresponding to the first candidate word and a database entity corresponding to the second candidate word, and a smaller intersection set of the database entity corresponding to the first candidate word and the database entity corresponding to the second candidate word indicates a larger pairing probability and a larger matching index.

With reference to the seventh or the eighth possible implementation manner, in a ninth possible implementation manner, the sequence distance is determined by a distance between the first candidate word and the second candidate word in the annotation information or the query statement, a larger distance between the first candidate word and the second candidate word in the annotation information or the query statement indicates a larger sequence distance and a smaller matching index, and a quantity of words between the first candidate word and the second candidate word in the annotation information or the query statement indicates a length of the distance.

With reference to any one of the seventh to the ninth possible implementation manners, in a tenth possible implementation manner, the matching degree of the database data type is determined according to whether a database data type of the first candidate word is consistent with that of the second candidate word, a matching degree of a database data type when the database data type of the first candidate word is consistent with that of the second candidate word is greater than a matching degree of a database data type when the database data type of the first candidate word is inconsistent with that of the second candidate word, and the matching index is positively correlated with the matching degree of the database data type.

With reference to any one of the seventh to the tenth possible implementation manners, in an eleventh possible implementation manner, the language habit constraint is determined according to whether the first candidate word and the second candidate word conform to a database or a language habit, a language habit constraint when the first candidate word and the second candidate word conform to the database or the language habit is less than a language habit constraint when the first candidate word and the second candidate word do not conform to the database or the language habit, and the matching index is negatively correlated with the language habit constraint.

With reference to the first aspect and any one of the first to the eleventh possible implementation manners, in a twelfth possible implementation manner, the generating a query target according to the annotation information includes: determining that a word whose label in the annotation information is an attribute name satisfies a preset condition and/or is an acnodal word, where the acnodal word has no corresponding word whose label is an attribute value; and using the attribute name of the word whose label in the annotation information is the attribute name as the query target.

According to a second aspect, a database query device is provided, where the device includes: an acquiring unit, configured to acquire a to-be-queried statement, where the to-be-queried statement is a natural language query statement; a dividing unit, configured to divide the to-be-queried statement according to a preset word stock to obtain N words, where N is an integer greater than or equal to 1; a determining unit, configured to determine, from a preset database, at least one candidate database entity of a first word, where the first word is any word in the N words; an annotating unit, configured to separately annotate a label on each word in the N words to obtain annotation information corresponding to the to-be-queried statement, where the annotation information includes the N words and a label one-to-one corresponding to each word in the N words, a label one-to-one corresponding to the first word is used to indicate a data type of the first word, and the label of the first word includes an attribute name or an attribute value; a first generating unit, configured to generate K query conditions according to the annotation information, where each query condition in the K query conditions includes a second word, an operator, and a third word, the operator indicates a relationship between the second word and the third word, a label of the second word is an attribute name, a label of the third word is an attribute value, and K is an integer greater than or equal to 1 and less than N; a second generating unit, configured to generate a query target according to the annotation information, where the query target includes a database entity of at least one word in the N words, a label of the at least one word is an attribute name, and a database entity of each word in the at least one word is one of at least one candidate database entity of each word; and a query unit, configured to perform query according to the K query conditions and the query target to obtain a query result.

With reference to the second aspect, in a first possible implementation manner, the dividing unit divides the to-be-queried statement according to the preset word stock to obtain N initial words; and standardizes the N initial words according to a preset rule to obtain the N words.

With reference to the second aspect or the first possible implementation manner of the second aspect, in a second possible implementation manner, the determining unit determines, from the preset database, n initial candidate database entities of the first word, where n is an integer greater than or equal to 1; and when n is greater than 1, determines relevancy between each initial candidate database entity in the n initial candidate database entities and the first word, and determines an initial candidate database entity, relevancy between which and the first word is greater than a preset threshold, in the n initial candidate database entities as the at least one candidate database entity of the first word; or when n is equal to 1, determines the n initial candidate database entities of the first word as the at least one candidate database entity of the first word.

With reference to the second possible implementation manner of the second aspect, in a third possible implementation manner, the determining unit determines the relevancy between each initial candidate database entity in the n initial candidate database entities and the first word according to at least one of the following methods: a hit rate, vector space cosine, and an edit distance.

With reference to the second aspect and any one of the first to the third possible implementation manners of the second aspect, in a fourth possible implementation manner, the device further includes: a combining unit, configured to: before the first generating unit generates the K query conditions according to the annotation information, combine, according to a candidate database entity of a word in the annotation information, words successively labeled as an attribute name in the annotation information, so as to obtain a first combined word, where the first combined word is an intersection set of candidate database entities of the words successively labeled as an attribute name in the annotation information; and use the first combined word to replace the words successively labeled as an attribute name in the annotation information, so as to update the annotation information; and/or combine, according to a candidate database entity of a word in the annotation information, words successively labeled as an attribute value in the annotation information, so as to obtain a second combined word, where the second combined word is an intersection set of candidate database entities of the words successively labeled as an attribute value in the annotation information; and use the second combined word to replace the words successively labeled as an attribute value in the annotation information, so as to update the annotation information; where the first generating unit generates the K query conditions according to updated annotation information, and the second generating unit generates the query target according to the updated annotation information.

With reference to the second aspect and any one of the first to the fourth possible implementation manners of the second aspect, in a fifth possible implementation manner, the first generating unit generates M candidate query conditions according to the annotation information, where each candidate query condition in the M candidate query conditions includes a correspondence among a first candidate word, an operator, and a second candidate word, a label of the first candidate word is an attribute name, a label of the second candidate word is an attribute value, and M is an integer greater than or equal to K; determines a matching index between the first candidate word and the second candidate word of each candidate query condition; and determines K candidate query conditions that are in the M candidate query conditions and whose matching index is greater than a preset threshold as the K query conditions.

With reference to the fifth possible implementation manner of the second aspect, in a sixth possible implementation manner, the first generating unit generates M initial candidate query conditions according to the annotation information; and performs disambiguation processing on the M initial candidate query conditions according to user information to obtain the M candidate query conditions, where the disambiguation processing includes: removing, according to the user information, ambiguity of an initial candidate query condition in which the ambiguity exists in the M initial candidate query conditions, and the user information includes at least one of: hardware information of a terminal device, software information of a terminal system, user data stored in a memory or a storage device of a terminal, a historical operation of a user, and setting of the user.

With reference to the fifth or the sixth possible implementation manner of the second aspect, in a seventh possible implementation manner, the first generating unit determines the matching index according to at least one of: a pairing probability, a sequence distance, a matching degree of a database data type, and a language habit constraint of the first candidate word and the second candidate word.

With reference to the seventh possible implementation manner of the second aspect, in an eighth possible implementation manner, the pairing probability is determined by an intersection set of a database entity corresponding to the first candidate word and a database entity corresponding to the second candidate word, and a smaller intersection set of the database entity corresponding to the first candidate word and the database entity corresponding to the second candidate word indicates a larger pairing probability and a larger matching index.

With reference to the seventh or the eighth possible implementation manner of the second aspect, in a ninth possible implementation manner, the sequence distance is determined by a distance between the first candidate word and the second candidate word in the annotation information or the query statement, a larger distance between the first candidate word and the second candidate word in the annotation information or the query statement indicates a larger sequence distance and a smaller matching index, and a quantity of words between the first candidate word and the second candidate word in the annotation information or the query statement indicates a length of the distance.

With reference to any one of the seventh to the ninth possible implementation manners of the second aspect, in a tenth possible implementation manner, the matching degree of the database data type is determined according to whether a database data type of the first candidate word is consistent with that of the second candidate word, a matching degree of a database data type when the database data type of the first candidate word is consistent with that of the second candidate word is greater than a matching degree of a database data type when the database data type of the first candidate word is inconsistent with that of the second candidate word, and the matching index is positively correlated with the matching degree of the database data type.

With reference to any one of the seventh to the tenth possible implementation manners of the second aspect, in an eleventh possible implementation manner, the language habit constraint is determined according to whether the first candidate word and the second candidate word conform to a database or a language habit, a language habit constraint when the first candidate word and the second candidate word conform to the database or the language habit is less than a language habit constraint when the first candidate word and the second candidate word do not conform to the database or the language habit, and the matching index is negatively correlated with the language habit constraint.

With reference to the second aspect and any one of the first to the eleventh possible implementation manners, in a twelfth possible implementation manner, the second generating unit determines that a word whose label in the annotation information is an attribute name satisfies a preset condition and/or is an acnodal word, where the acnodal word has no corresponding word whose label is an attribute value; and uses the attribute name of the word whose label in the annotation information is the attribute name as the query target.

Based on the foregoing technical solutions, in the embodiments of the present invention, a query target and a query condition are generated for a to-be-queried statement that is a natural language query statement, and query is performed according to the query target and the query condition, so as to obtain a query result. In this way, a database can be queried according to a user request. According to the embodiments of the present invention, a user does not need to be familiar with database query language, which improves user experience.

### BRIEF DESCRIPTION OF THE DRAWINGS

To describe the technical solutions in the embodiments of the present invention more clearly, the following briefly introduces the accompanying drawings required for describing the embodiments of the present invention. Apparently, the accompanying drawings in the following description show merely some embodiments of the present invention, and persons of ordinary skill in the art may still derive other drawings from these accompanying drawings without creative efforts.

FIG. 1 is a schematic flowchart of a database query method according to an embodiment of the present invention;

FIG. 2 is a schematic flowchart of a database query method according to another embodiment of the present invention;

FIG. 3 is a schematic block diagram of a database query device according to an embodiment of the present invention; and

FIG. 4 is a schematic block diagram of a database query device according to another embodiment of the present invention.

### DETAILED DESCRIPTION

The following clearly describes the technical solutions in the embodiments of the present invention with reference to the accompanying drawings in the embodiments of the present invention. Apparently, the described embodiments are some but not all of the embodiments of the present invention. All other embodiments obtained by persons of ordinary skill in the art based on the embodiments of the present invention without creative efforts shall fall within the protection scope of the present invention.

It should be understood that in the embodiments of the present invention, user equipment (UE) includes but is not limited to a mobile station (MS), a mobile terminal (Mobile Terminal), a mobile telephone (Mobile Telephone), a handset (handset), portable equipment (portable equipment), and the like. The user equipment may communicate with one or more core networks by using a radio access network (RAN) . For example, the user equipment may be a mobile phone (or referred to as a “cellular” phone), or a computer having a wireless communication function; or the user equipment may be a computer, a Pad, or a portable, pocket-sized, handheld, computer built-in, or in-vehicle mobile apparatus.

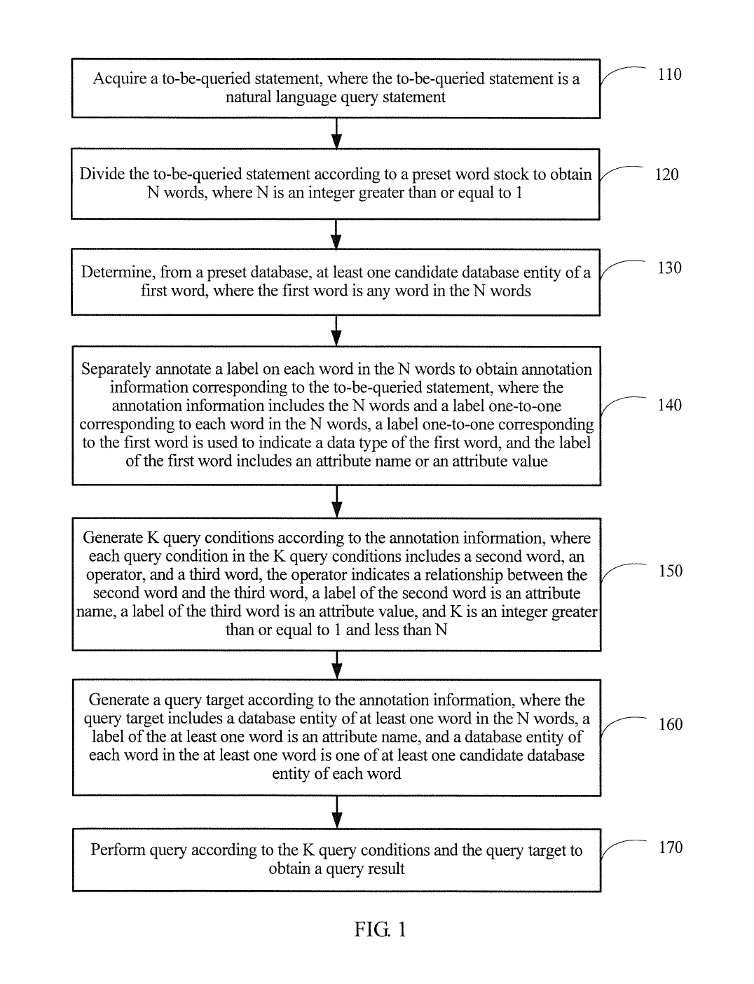

FIG. 1 is a schematic flowchart of a database query method according to an embodiment of the present invention. The method shown in FIG. 1 may be executed by a database query device. Specifically, the method shown in FIG. 1 includes:

110. Acquire a to-be-queried statement, where the to-be-queried statement is a natural language query statement.

120. Divide the to-be-queried statement according to a preset word stock to obtain N words, where N is an integer greater than or equal to 1.

130. Determine, from a preset database, at least one candidate database entity of a first word, where the first word is any word in the N words.

140. Separately annotate a label on each word in the N words to obtain annotation information corresponding to the to-be-queried statement, where the annotation information includes the N words and a label one-to-one corresponding to each word in the N words, a label one-to-one corresponding to the first word is used to indicate a data type of the first word, and the label of the first word includes an attribute name or an attribute value.

150. Generate K query conditions according to the annotation information, where each query condition in the K query conditions includes a second word, an operator, and a third word, the operator indicates a relationship between the second word and the third word, a label of the second word is an attribute name, a label of the third word is an attribute value, and K is an integer greater than or equal to 1 and less than N.

160. Generate a query target according to the annotation information, where the query target includes a database entity of at least one word in the N words, a label of the at least one word is an attribute name, and a database entity of each word in the at least one word is one of at least one candidate database entity of each word.

170. Perform query according to the K query conditions and the query target to obtain a query result.

According to this embodiment of the present invention, a query target and a query condition are generated for a to-be-queried statement that is a natural language query statement, and query is performed according to the query target and the query condition, so as to obtain a query result. In this way, a database can be queried according to a user request. According to this embodiment of the present invention, a user does not need to be familiar with database query language, which improves user experience.

It should be understood that the N words may be N words with a practical meaning in Y words in the to-be-queried statement. For example, for a query statement “a quantity of people who are older than 30 years old”, Y=4 words may be obtained by means of division: “older than”, “30 years old”, “who are”, and “a quantity of people”, where the N words are two words in the four words, that is, N=2, and the two words are “30 years old” and “a quantity of people”. In other words, each word in the N words has a candidate database entity, that is, the N words may be words with a candidate database entity in the Y words. N may be an integer greater than or equal to 1. It should further be understood that a database entity is an attribute name or an attribute value in a database, or the database entity may be a word with a practical meaning, for example, may be a notional word.

It should be understood that the operator may include multiple symbols, and for example, may be, ≧, ≦, =, <, >. An operator included in a query statement may be recognized in a manner of a predefined rule. For example, a predefined operator and rule pair is “<: under **|less than”; then, for “under the age of 30”, a query condition (age, operator, 30) is recognized, “under **” is an operator “<” according to the predefined rule, and then a complete query condition is (age, <, 30).

It should be understood that the annotation information in this embodiment of the present invention may also be expressed as an annotation sequence or annotation sequence information.

It should be noted that in 150, at least one of the second word and the third word is a database entity in candidate database entities of the N words. The second word may also be referred to as a second database entity, and the third word may also be referred to as a third database entity. In other words, in 150, the K query conditions are generated according to the annotation information, where each query condition in the K query conditions includes a second database entity, an operator, and a third database entity, the operator indicates a relationship between the second database entity and the third database entity, a label of the second database entity is an attribute name, and a label of the third database entity is an attribute value. At least one of the second database entity and the third database entity is a database entity in the candidate database entities of the N words, where 1≦K<N.

Optionally, in 170, a target query statement may be generated according to the K query conditions and the query target, where the target query statement is database query language. The target query statement is executed to obtain the query result.

For example, a user enters a query statement (to-be-queried statement) “name of a senior engineer younger than 30 years old”. After the foregoing process, it may be obtained that: query conditions are “age<30” and “Job=senior engineer”, and a query target is “name” (name). Then, a generated SQL statement (target query statement) is: select name from view where age<30 and job=‘senior engineer’.

It should be understood that the database query language may be SQL language, or may be NO-SQL language, which is not limited in this embodiment of the present invention.

Optionally, as another embodiment, in 120, the to-be-queried statement is divided according to the preset word stock to obtain N initial words, and the N initial words are standardized according to a preset rule to obtain the N words.

It should be understood that a word in this embodiment of the present invention may be a word group, a phrase, or the like.

Specifically, the to-be-queried statement may be parsed according to aspects such as a concept, a relationship, and an attribute of a word, a word group, or a phrase of natural language. For example, word segmentation may be performed on a user query statement (to-be-queried statement) according to a concept, a relationship, an attribute, and the like of a word, a word group, or a phrase, that is, the to-be-queried statement is segmented into N words, word groups, or phrases (initial words).

Named entity recognition is performed on the user query statement according to the concept, the relationship, the attribute, and the like of the word, the word group, or the phrase, that is, an entity name and category of a specific word, word group, or phrase in the user query statement are identified. For example, for a user query statement “achievement of a sales department in the past three years”, a result of a named entity may be “sales department-an organization name”, “past three years-time”, and the like. In addition, the specific word, word group, or phrase thereof may further be standardized into a specific word. For example, “past three years” may be standardized into a date and time three years before current time. Finally, the N words are obtained.

According to this embodiment of the present invention, the user query statement may further be parsed in terms of syntax of natural language, which includes but is not limited to: annotating a part of speech for each word according to a lexical analysis result and a syntax result of the natural language, dividing a short sentence including multiple words and phrases, and generating a syntax structure chart, so as to subsequently generate a query condition.

It should be understood that the word stock stores an association between a specific word, word group, or phrase and an entity indicating a concept, an attribute, and a relationship of the specific word, word group, or phrase. The word stock may further store a synonym, a near-synonym, and the like of a word. The word stock may be, but is not limited to being, stored in a file or a database.

Optionally, as another embodiment, in 130, n initial candidate database entities of the first word in the N words may be determined from the preset database according to the N words, where n is an integer greater than or equal to 1; and when n is greater than 1, relevancy between each initial candidate database entity in the n initial candidate database entities and the first word is determined, and an initial candidate database entity, relevancy between which and the first word is greater than a preset threshold, in the n initial candidate database entities is determined as the at least one candidate database entity of the first word; or when n is equal to 1, the n initial candidate database entities of the first word are determined as the at least one candidate database entity of the first word.

It should be understood that the first word may be any word in the N words.

Further, as another embodiment, that the relevancy between each initial candidate database entity in the n initial candidate database entities and the first word is determined includes: determining the relevancy between each initial candidate database entity in the n initial candidate database entities and the first word according to at least one of the following methods: a hit rate, vector space cosine, an edit distance, and the like.

Specifically, the relevancy may also be referred to as similarity. For example, relevancy between each initial candidate database entity in at least one initial candidate database entity and each word may be determined according to the hit rate, the vector space cosine, the edit distance, and the like, and entities in the at least one initial candidate database entity are sorted or filtered. It is assumed that the edit distance is used as a manner for calculating the similarity. Candidate database entities of a keyword “Peking University” are {attribute value 1—Peking University, attribute value 2—Shenzhen Branch of Peking University}, an edit distance of the attribute value 1 is 0, and an edit distance of the attribute value 2 is 4. The edit distance of the attribute value 1 is less than that of the attribute value 2, and then it is considered that the attribute value 1 is more similar. It is assumed that an edit distance filtering threshold is set to 1, and then the attribute value 2 is filtered out.

It should be understood that the preset threshold is a determined value, may be considered as a value set in advance, or may be considered as a value obtained in a previous forecasting process. Preferably, the preset threshold in this embodiment of the present invention may be directly used, and can be obtained without a need of calculation or another solution.

Optionally, as another embodiment, in 140, a database entity library may be retrieved for each to-be-recognized entity to obtain at least one candidate database entity. A retrieval manner may be directly using a to-be-recognized entity or a data type of a to-be-recognized entity. If the to-be-recognized entity is of a time/date type or a value type, the to-be-recognized entity is a to-be-determined attribute value by default. For example, after step 120 is performed on a user query statement “how many people graduated from Peking University in 2013”, in other words, after preprocessing, several keyword sequences (2013/Date, graduated, Peking University) are output, “2013” is a time/date type, and then an attribute name of the same data type as the time/date type is retrieved. For example, possible candidate database entities are {attribute name 1—sales time; attribute name 2—entry time; attribute name 3—departure time . . . }. For “graduated”, possible candidate database entities are {attribute name 1—time of graduation; attribute name 2—school of graduation; attribute name 3—graduation certificate}. For “Peking University”, possible candidate database entities are (attribute name 1—Peking University; attribute name 2—Shenzhen Branch of Peking University). It can be seen from the foregoing that “2013” is a default to-be-determined attribute value and is annotated as a value (attribute value), all the candidate database entities of “graduated” are attribute names and may be annotated as a field (attribute name), both the candidate database entities of “Peking University” are attribute values and may be annotated as a value, and then output annotation information is (2013/value, graduated/field, Peking University/value).

Optionally, as another embodiment, before 150, the method in this embodiment of the present invention further includes:

combining, according to a candidate database entity of a word in the annotation information, words successively labeled as an attribute name in the annotation information, so as to obtain a first combined word, where the first combined word is an intersection set of candidate database entities of the words successively labeled as an attribute name in the annotation information; and using the first combined word to replace the words successively labeled as an attribute name in the annotation information, so as to update the annotation information; and/or combining, according to a candidate database entity of a word in the annotation information, words successively labeled as an attribute value in the annotation information, so as to obtain a second combined word, where the second combined word is an intersection set of candidate database entities of the words successively labeled as an attribute value in the annotation information; and using the second combined word to replace the words successively labeled as an attribute value in the annotation information, so as to update the annotation information; where in 150, the K query conditions are generated according to updated annotation information; and in 160, the query target is generated according to the updated annotation information.

Specifically, combining the words successively labeled as an attribute name or an attribute value in the annotation information includes: consolidating P(Field|field_1, field_2 . . . field_n) or P(Value|value_1, value_2 . . . value_n). Specifically, when successive field or value labels appear in the annotation information, an attempt is made to combine field_1, field_2 . . . field_n or value_1, value_2 . . . value_n in a greedy manner, and a probability of reducing a quantity of original candidate database entities is calculated. For example, for a user query statement “responsibilities of a post of Zhang San, candidate database entities of a keyword “post” may be {post name, post responsibilities, post type . . . }, candidate database entities of a keyword “responsibilities” may be {job responsibilities, post responsibilities . . . }, and annotation information corresponding to the user query statement is (Zhang San/value, post/field, responsibilities/field), where “post” and “responsibilities” are successive fields that appear, and then an attempt is made to combine “post” and “responsibilities”. Whether “post” and “responsibilities” are finally combined is determined mainly by calculating an intersection set of candidate database entities of the two. If a quantity of candidate database entities in the intersection set decreases (which is not 0), it indicates that P(Field|post, responsibilities) is greater than P(Field|post) and P(Field|responsibilities), and then “post” and “responsibilities” are directly combined. Next combination continues to be performed until a maximum value appears in P(Field|field_1, field_2 . . . field_n) or P(Value|value_1, value_2 . . . value_n), and the annotation information is updated. For example, after combination is performed on the current query statement, the annotation information is updated to (Zhang San/value, post responsibilities/field)

Optionally, as another embodiment, in 150, M candidate query conditions are generated according to the annotation information, where each candidate query condition in the M candidate query conditions includes a correspondence among a first candidate word, an operator, and a second candidate word, a label of the first candidate word is an attribute name, a label of the second candidate word is an attribute value, and M is an integer greater than or equal to K;

a matching index between the first candidate word and the second candidate word of each candidate query condition is determined; and

K candidate query conditions that are in the M candidate query conditions and whose matching index is greater than a preset threshold are determined as the K query conditions.

The M candidate query conditions are generated according to the annotation information.

In other words, a first candidate query condition is obtained according to the M candidate query conditions, and the first candidate query condition includes a correspondence among a first candidate word, an operator, and a second candidate word, where a label of the first candidate word is an attribute name, and a label of the second candidate word is an attribute value. At least one of the first candidate word and the second candidate word is a word in the N words. A matching index between the first candidate word and the second candidate word is determined, and when the matching index is greater than a preset parameter threshold, the first candidate query condition is determined as a first query condition, where the first candidate word is used as a first word, and the second candidate word is used as a second word.

Specifically, the annotation information may be scanned, and a field and a value are paired. Alternatively, a candidate query condition is generated according to an implicit Field. For example, for a user query statement “senior engineer younger than 30 years old”, annotation information is (age/field, younger than, 30 years old/value, senior engineer/value), where “age” corresponds to an attribute name “Age”, “30 years old” implicitly refers to an attribute value of “Age”, and “senior engineer” implicitly refers to an attribute value of an attribute name “Job”. It is assumed that no ambiguity or no multiple candidate database entities exist, and then the field and the value can be paired. For “senior engineer/value” that is not paired, an implicit field is used to generate candidate query conditions (age, operator, 30) and “(Job, operator, senior engineer)”.

Further, as another embodiment, that the M candidate query conditions are generated according to the annotation information includes: generating M initial candidate query conditions according to the annotation information; and performing disambiguation processing on the M initial candidate query conditions according to user information to obtain the M candidate query conditions, where the disambiguation processing includes: removing, according to the user information, ambiguity of an initial candidate query condition in which the ambiguity exists in the M initial candidate query conditions, and the user information includes at least one of: hardware information of a terminal device, software information of a terminal system, user data stored in a memory or a storage device of a terminal, a historical operation of a user, and setting of the user.

Specifically, ambiguity in the user query statement may be removed according to personal information of the user. For example, in an HR (Human Resource) database search system of an enterprise, a user queries “how many people work as a senior engineer in a department”, where “department” is an entity with ambiguity, and whether “department” refers to a department or several departments is unknown. However, according to personal information of a user performing query, such as an employee ID, the name, and a department, it can be determined that “department” in the query statement implicitly refers to a department in which the user works, and disambiguation processing is performed on “department” according to the user information to obtain a query condition.

It should be understood that the personal information of the user includes personal information data of the user, including but not limited to: hardware information of a terminal device, which includes but is not limited to date and clock information (for example but not limited to a current date, time, and time zone), position information (for example but not limited to a GPS, a nation, and a city), information generated by using a sensor (for example but not limited to information such as acceleration, magnetic force, a direction, a gyroscope, ray sensing, pressure, a temperature, face sensing, gravity, and a rotating vector), or a combination of the foregoing manners; software information of a terminal system, which includes but is not limited to an operating system, running software, a process, a service status, an event, and provided data; user data stored in a memory or a storage device of a terminal, which includes but is not limited to a short text, an address book, a memo, a reminder, a photo, an application, a video, an audio, a mail, a bookmark, a web browsing record, a commodity/service purchase record, a hotel booking record, and a ticket purchase record; a historical operation of the user, which includes but is not limited to a historical query statement of the user; and setting of the user, which includes but is not limited to setting of the user information (for example, a name, a telephone number, an address, and an account) and a user preference.

Optionally, as another embodiment, that the matching index between the first candidate word and the second candidate word of each candidate query condition is determined includes:

determining the matching index according to at least one of: a pairing probability, a sequence distance, a matching degree of a database data type, and a language habit constraint of the first candidate word and the second candidate word.

The matching index is negatively correlated with the pairing probability, the sequence distance, and the language habit constraint. The matching index is positively correlated with the matching degree of the database data type. Definitions of the pairing probability, the sequence distance, the matching degree of the database data type, and the language habit constraint are as follows: The pairing probability refers to a quantity of intersection sets of a database entity corresponding to the first candidate word and a database entity corresponding to the second candidate word, and a smaller intersection set of the database entity corresponding to the first candidate word and the database entity corresponding to the second candidate word indicates a larger pairing probability; the sequence distance may also be referred to as a statement distance, which refers to a quantity of words or characters between the first candidate word and the second candidate word in the annotation information or the query statement, and more words or characters between the first candidate word and the second candidate word in the query statement indicate a larger sequence distance; the matching degree of the database data type refers to whether a database data type of the first candidate word matches (is consistent with) that of the second candidate word, and a matching degree of a database data type when the database data type of the first candidate word matches that of the second candidate word is greater than a matching degree of a database data type when the database data type of the first candidate word does not match that of the second candidate word; and the language habit constraint refers to whether the first candidate word and the second candidate word conform to a database or a language habit, and a language habit constraint when the first candidate word and the second candidate word conform to the database or the language habit is less than a language habit constraint when the first candidate word and the second candidate word do not conform to the database or the language habit.

In this embodiment of the present invention, the foregoing characteristic values (the pairing probability, the sequence distance, the matching degree of the database data type, and the language habit constraint) may be calculated according to a context of the user query statement for a to-be-recognized entity in a sequence in which ambiguity or multiple candidate database entities exist.

Specifically, the pairing probability is determined by the intersection set of the database entity corresponding to the first candidate word and the database entity corresponding to the second candidate word, and a smaller intersection set of the database entity corresponding to the first candidate word and the database entity corresponding to the second candidate word indicates a larger pairing probability and a larger matching index.

The pairing probability P(Field-Value|field, value) indicates a probability that a field and a value in a sequence are paired and a query condition (Field, operator, Value) is generated. A main manner is determined according to whether candidate database entities of the field and the value have an intersection set and according to a quantity of elements of the intersection set. For example, for a user query statement “how many postgraduates graduated last year”, it is assumed that candidate database entities of “last year” are {time of graduation, entry time, departure time . . . }, candidate database entities of “graduated” are {school of graduation, graduation certificate, time of graduation . . . }, and annotation information is (last year/value, graduated/field, postgraduates/value). When P(Field-Value|graduated, last year) is calculated, “last year” and “graduated” have an intersection set {time of graduation}, and it may be considered that P(Field-Value|graduated, last year)=s (s>0), that is, a probability of generating a query condition (time of graduation, operator, last year) is s. If there are m elements in the intersection set, P(Field-Value|graduated, last year)=s/m. However, for P(Field-Value|graduated, postgraduates), because there is no intersection set, P is 0.

Specifically, the sequence distance is determined by a distance between the first candidate word and the second candidate word in the annotation information or the query statement, a larger distance between the first candidate word and the second candidate word in the annotation information or the query statement indicates a larger sequence distance and a smaller matching index, and a quantity of words between the first candidate word and the second candidate word in the annotation information or the query statement indicates a length of the distance.

The sequence distance L(Field-Value|field, value) indicates a distance between a field and a value when the field and the value in a sequence are paired and a query condition (Field, operator, Value) is generated. A smaller distance indicates a greater probability of generating the query condition. A main calculation manner is determined according to a distance between a field and a value in the annotation information or the query statement. For example, for (age/field, younger than, 30 years old/value, job level/field, greater than, 18/value), “age” and “30 years old” are separated by “younger than” in the sequence, that is, L(Field-Value|age, 30 years old) is 2, and L(Field-Value|age, 18) is 8.

Specifically, the matching degree of the database data type is determined according to whether a database data type of the first candidate word is consistent with that of the second candidate word, a matching degree of a database data type when the database data type of the first candidate word is consistent with that of the second candidate word is greater than a matching degree of a database data type when the database data type of the first candidate word is inconsistent with that of the second candidate word, and the matching index is positively correlated with the matching degree of the database data type.

The matching degree of the database data type Type (Field-Value|field, value) indicates whether a database data type of a field in a sequence is consistent with a database data type of a value. If the database data type of the field in the sequence is consistent with the database data type of the value, a possibility of generating a query condition by means of pairing is greater. For example, a database data type of “age/field” is a value type. Therefore, for “18/value” of the value type, Type(Field-Value|age, 18)=1, and for “China/value” of a character type, Type(Field-Value|age, China)=0.

Specifically, the language habit constraint is determined according to whether the first candidate word and the second candidate word conform to a database or a language habit, a language habit constraint when the first candidate word and the second candidate word conform to the database or the language habit is less than a language habit constraint when the first candidate word and the second candidate word do not conform to the database or the language habit, and the matching index is negatively correlated with the language habit constraint.

The language habit constraint C(Field-Value|field, value) indicates whether a value conforms to a constraint of a field in a database or in a language habit when the field and the value in a sequence are paired. If the value conforms to the constraint of the field in the database or in the language habit, a possibility of generating a query condition by means of pairing is greater, and the constraint herein generally refers to quantifier and value range constraints. For example, for “job level/field” and “30 years old/value” in (age/field, younger than, 30 years old/value, job level/field, greater than, 25/value), because a quantifier “year” does not conform to a quantifier constraint of “job level”, C(Field-Value|job level, 30 years old) is 0. It is assumed that a value range constraint of “job level/field” in the database is 13-21; then, for “job level/field” and “25/value”, because the value does not conform to the constraint, C(Field-Value|job level, 25) is 0.

After the foregoing processing, a matching index of a query condition (Field, operator, Value) generated by pairing the field and the value may be a linear weighted value of the foregoing characteristic values. For example, matching index Score=z1*P+z2*L+z3*Type+z4*C, where z1, z2, z3, and z4 are predetermined weighted values.

Finally, by setting a preset threshold (a filtering rule), the query condition is obtained by means of screening and output.

Optionally, as another embodiment, in 160, it may be determined that a word whose label in the annotation information is an attribute name satisfies a preset condition and/or is an acnodal word, where the acnodal word has no corresponding word whose label is an attribute value and no corresponding word implicitly labeled as an attribute value; and the attribute name of the word whose label in the annotation information is the attribute name is used as the query target.

Specifically, a preset condition may include a manner of syntax or a predefined rule. In other words, a query target in a user query statement or in annotation information may be recognized in the manner of syntax or a predefined rule. For example, the preset condition includes that: there is “of” before a word whose label is an attribute name. For example, the preset condition may be “a field 1 and a field 2 of *”, which indicates that query targets are the field 1 and the field 2. When a user enters a query statement similar to “an employee ID and a department of Zhang San”, annotation information is (Zhang San/value, of, employee ID/field, and, department/field), which conforms to the predefined rule, where “employee ID” and “department” are query targets. Similarly, the preset condition may be “a field of *”.

In this embodiment of the present invention, the acnodal word may also be used as a query target. For example, if there is a field with which no value is paired, the field is ignored or added into the query target; if there is a value with which no field is paired, and candidate database entities of the value have a same implicit field, a query condition is generated by pairing the implicit field and the value, or otherwise, the value is ignored. For example, for a user query statement “age department of Zhang San”, there is no value that is paired with “age/field”, and “age/field” is not a query target. Therefore, “age/field” is ignored or added into the query target. For example, for a user query statement “achievement of a sales department in the past three years”, candidate database entities of “sales department/value” are {attribute value 1—sales department for mobile phones, attribute value 2—sales department for servers}. Both the candidate database entities have a same implicit field—“department”, and then query conditions (department, operator, sales department for mobile phones) and (department, operator, sales department for servers) are generated.

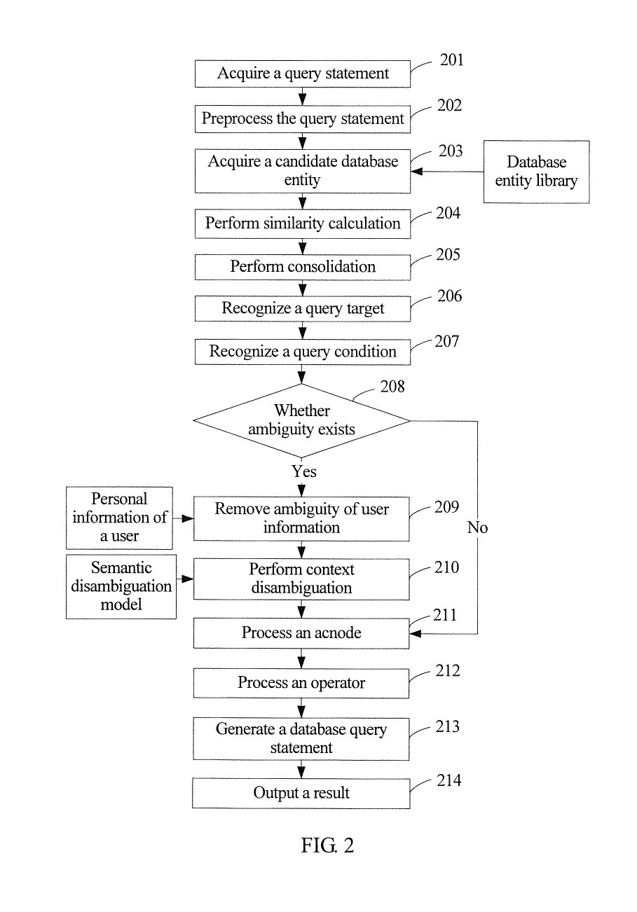

The database query method in this embodiment of the present invention is described in the foregoing in detail with reference to FIG. 1. A database query method in an embodiment of the present invention is described in the following in further detail with reference to a specific example shown in FIG. 2. It should be noted that the example shown in FIG. 2 is intended to help persons skilled in the art better understand the embodiments of the present invention, instead of limiting the scope of the embodiments of the present invention. Persons skilled in the art certainly can make various equivalent modifications or changes according to the example shown in FIG. 2, which also fall within the protection scope of the embodiments of the present invention.

It should be understood that sequence numbers of the foregoing processes do not mean execution sequences. The execution sequences of the processes should be determined according to functions and internal logic of the processes, and should not be construed as any limitation on the implementation processes of the embodiments of the present invention.

FIG. 2 is a schematic flowchart of a database query method according to another embodiment of the present invention. The method shown in FIG. 2 includes:

201. Acquire a query statement.

Specifically, a natural language query statement entered by a user is received. For example, the query statement may be “name of a post of a person who graduated from PKU, is younger than 30, and works at a level greater than level 18 in our department last year”.

202. Preprocess the query statement.

Specifically, a preprocessing process includes performing sentence segmentation, word segmentation, part-of-speech annotation, named entity recognition, syntax analysis, and the like on the query statement. Meanwhile, standardization is performed. For example, “last year” in the query statement is standardized into 2013 (it is assumed that current time is 2014) and is associated with an entity “time”. “PKU” is associated with an entity “organization name”, “30” and “level 18” are associated with a quantifier, and so on. A direct object “PKU” of a predicate (verb) “graduate” and the like are recognized.

203. Acquire a candidate database entity.

Specifically, a database entity library is retrieved for each to-be-recognized entity according to a preprocessing result, and one or more candidate database entities—attribute name (field) or attribute value (value) are returned. For a to-be-recognized entity such as a time/date type or a number type, an attribute name of a same data type is acquired from a database and is used as a candidate database entity of the to-be-recognized entity. For another keyword of a character type, an attribute name/attribute value including the keyword or a synonym is acquired from attribute names/attribute values and is used as a candidate database entity. If a to-be-recognized entity is known as another name of a database entity by using priori knowledge, and then a formal name of the database entity should be used to acquire a relevant candidate database entity. For example, candidate database entities of “graduated” in the query statement may be {time of graduation, school of graduation, graduation certificate . . . }. For “PKU”, it is a short name of “Peking University”, and a formal database entity “Peking University” should be used to acquire another relevant candidate database entity, for example, {Peking University, Graduate School of Peking University, Shenzhen Institute of Peking University . . . }. A database entity only hitting the keyword such as “Beijing Institute of Technology” should not be included. Annotation information (2013/value, our department, graduated/field, Peking University/value, age/field, younger than, 30/value, work/field, greater than, level 18/value, person, at, post/field, of, name/field) corresponding to the user query statement is finally output.

204. Perform similarity calculation.

Specifically, similarity (relevancy) between a to-be-recognized entity or a formal name of a database entity and a candidate database entity is calculated. The similarity may be determined according to at least one of: a hit rate, vector space cosine, and an edit distance. For example, the similarity is calculated by using linear weighting of the hit rate and a coverage rate. Hit rate={weight sum of an intersection set of a keyword or a formal name of a database entity and a candidate database entity}/{weight sum of the keyword}. For example, an intersection set of “graduated” and the candidate database entity “time of graduation” in the query statement is {graduate}, a weight of the intersection set is w1, and then a hit rate of the keyword “graduated” and the candidate database entity “time of graduation”=w1/w1=1.0. Coverage rate={weight sum of an intersection set of a keyword or a formal name of a database entity and a candidate database entity}/{weight sum of the candidate database entity}. For example, the intersection set of “graduated” and the candidate database entity “time of graduation” in the query statement is {graduate} , the weight of the intersection set is w1, and “time of graduation” includes two words: “graduation” and “time”. It is assumed that a weight of “time” is w2; then, a weight sum of “time of graduation”=w1+w2, and a coverage rate of the keyword “graduated” and the candidate database entity “time of graduation”=w1/(w1+w2). Finally, similarity of the keyword “graduated” and the candidate database entity “time of graduation”=a1*hit rate+a2*coverage rate, where a1 and a2 are weights of the hit rate and the coverage rate respectively, and a1 and a2 may be preset values.

205. Perform consolidation.

Specifically, words successively labeled as an attribute name or an attribute value in the annotation information are combined according to a candidate database entity of a word in the annotation information to obtain a combined word, where the combined word is an intersection set of candidate database entities of the words successively labeled as an attribute name or an attribute value in the annotation information; and the combined word is used to replace the words successively labeled as an attribute name or an attribute value in the annotation information, so as to update the annotation information.

In other words, words successively labeled as an attribute name in the annotation information are combined according to a candidate database entity of a word in the annotation information to obtain a first combined word, where the first combined word is an intersection set of candidate database entities of the words successively labeled as an attribute name in the annotation information; and the first combined word is used to replace the words successively labeled as an attribute name in the annotation information, so as to update the annotation information; and/or words successively labeled as an attribute value in the annotation information are combined according to a candidate database entity of a word in the annotation information to obtain a second combined word, where the second combined word is an intersection set of candidate database entities of the words successively labeled as an attribute value in the annotation information; and the second combined word is used to replace the words successively labeled as an attribute value in the annotation information, so as to update the annotation information.

Specifically, an output sequence (annotation information) is scanned, and it is found that “post” and “name” are successive fields, where candidate database entities of “post” are {post responsibilities, post name, post level}, and candidate database entities of “name” are {job name, post name}. A combination attempt is made, an intersection set of candidate database entities of “post” and “name” is {post name} , a quantity of elements is 1, and the quantity is less than an original quantity. The annotation information is updated to {2013/value, our department, graduated/field, Peking University/value, age/field, younger than, 30/value, work/field, greater than, level 18/value, person, at, post name/field}.

206. Recognize a query target.

Specifically, the query target in the user query statement is recognized in a manner of syntax or a predefined rule. For example, a predefined rule “a field of *” indicates that the query target is a field. A current query statement conforms to the rule, and the query target “post name” is generated.

207. Recognize a query condition.

Specifically, the annotation information is scanned, and a field and a value are paired. Alternatively, a candidate query condition is generated according to an implicit Field. Because multiple to-be--recognized entities in a sequence include multiple candidate database entities, it is determined that ambiguity exists and disambiguation needs to be performed.

208. Whether ambiguity exists.

Specifically, if the ambiguity exists, step 209 is executed; if the ambiguity does not exist, step 211 is executed.

209. Remove ambiguity of user information.

Specifically, disambiguation is performed on the query statement by using personal information of a user in a manner of a predefined rule. For example, in a case in which the user logs in, the query statement is entered, and a specific type of query condition is added in a default case or for a specific type of keyword. For a keyword such as “our department” in the annotation information, disambiguation is performed by adding (department, operator, department in which the user works) into the query condition with reference to the user information.

It should be understood that the personal information of the user includes personal information data of the user, including but not limited to: hardware information of a terminal device, which includes but is not limited to date and clock information (for example but not limited to a current date, time, and time zone), location information (for example but not limited to a GPS, a nation, and a city), information generated by using a sensor (for example but not limited to information such as acceleration, magnetic force, a direction, a gyroscope, ray sensing, pressure, a temperature, face sensing, gravity, and a rotating vector), or a combination of the foregoing manners; software information of a terminal system, which includes but is not limited to an operating system, running software, a process, a service status, an event, and provided data; user data stored in a memory or a storage device of a terminal, which includes but is not limited to a short text, an address book, a memo, a reminder, a photo, an application, a video, an audio, a mail, a bookmark, a web browsing record, a commodity/service purchase record, a hotel booking record, and a ticket purchase record; a historical operation of the user, which includes but is not limited to a historical query statement of the user; and setting of the user, which includes but is not limited to setting of the user information (for example, a name, a telephone number, an address, and an account) and a user preference.

210. Perform context disambiguation.

Specifically, according to a context of the user query statement, the following characteristic values are calculated for a to-be-recognized entity in which ambiguity or multiple candidate database entities exist. It is assumed that a candidate database entity of “age” is {age}, candidate database entities of “30” that may be obtained according to a data type are {age, job level, a quantity of probation days . . . }, and possible candidate database entities of “level 18” are {age, job level, a quantity of probation days . . . } according to a data type. The following gives an example of a calculation process when “age/field” and “30/value” are paired with “level 18/value”.

Specifically, a matching index may be determined according to at least one of: a pairing probability P, a sequence distance L, a matching degree Type of a database data type, and a language habit constraint C of the first candidate word and the second candidate word.

P(Field-Value|field, value) indicates a probability that a field and a value in a sequence are paired and a query condition (Field, operator, Value) is generated. A main manner is determined according to whether candidate database entities of the field and the value have an intersection set and according to a quantity of elements of the intersection set. For the annotation information, when P(Field-Value|age, 30) is calculated, the field and the value have an intersection set {age}, and a quantity of elements is 1. It may be considered that P(Field-Value|age, 30)=s (s>0), and a probability of generating a query condition (time of graduation, operator, last year) is s. Similarly, P(Field-Value|age, level 18)=s.

L(Field-Value|field, value) indicates a distance between a field and a value when the field and the value in a sequence are paired and a query condition (Field, operator, Value) is generated. A smaller distance indicates a greater probability of generating the query condition. A main calculation manner is determined according to a distance between a field and a value in the annotation information or the query statement. In the annotation information, L(Field-Value|age, 30) is 2, and L(Field-Value|age, level 18) is 8.

Type(Field-Value|field, value) indicates whether a database data type of a field in a sequence is consistent with a database data type of a value. If the database data type of the field in the sequence is consistent with the database data type of the value, a possibility of generating a query condition by means of pairing is greater. In the annotation information, Type(Field-Value|age, 30)=1, and Type(Field-Value|age, level 18)=1.

C(Field-Value|field, value) indicates whether a value conforms to a constraint of a field in a database or in a language habit when the field and the value in a sequence are paired. If the value conforms to the constraint of the field in the database or in the language habit, a possibility of generating a query condition by means of pairing is greater, and the constraint herein generally refers to quantifier and value range constraints. In the annotation information, C(Field-Value|age, 30)=1, and C(Field-Value|age, level 18)=0.

After the foregoing processing, a matching index of the age and 30 is:

Score1=z1*P(Field-Value|age, 30)+z2*L(Field-Value|age, 30)+z3*Type(Field-Value|age, 30)+z4*C(Field-Value|age, 30)=z1*s+z2*2+z3*1+z4*1=z1*s+z2*2+z3+z4;

a matching index of the age and level 18 is:

Score2=z1*P(Field-Value|age, level 18)+z2*L(Field-Value|age, level 18)+z3*Type(Field-Value|age, level 18)+z4*C(Field-Value|age, level 18)=z1*s+z2*2+z3*1+z4*0=z1*s+z2*8+z3,

where

z1, z2, z3, and z4 are weighted values generated offline in a machine learning manner. In other words, z1, z2, z3, and z4 are predetermined values and are stored in a semantic disambiguation model. In terms of design of the foregoing characteristics, characteristics (1), (3), and (4) are positive characteristics, and therefore z1, z3, and z4 are positive numbers; z2 is a negative characteristic, and a value of z2 is a negative value. It can be learned that Score1 is greater than Score2. Finally, query conditions are screened by setting a threshold or a filtering rule. For example, a query condition whose C (Field-Value field, value) is 0 is ignored, and then the query condition (age, operator, level 18) is ignored.

211. Process an acnode.

Specifically, if there is a field with which no value is paired, the field is ignored or added into the query target; if there is a value with which no field is paired, and candidate database entities of the value have a same implicit field, a query condition is generated by pairing the implicit field and the value, or otherwise, the value is ignored. According to the foregoing calculation, the current annotation information does not have an acnode.

212. Process an operator.

In other words, the operator is recognized. Specifically, an operator included in a query statement is recognized in a manner of a predefined rule. For example, a default operator is “=”, and another predefined operator and rule pair is “<: under**|less than”; then, for a query condition (age, operator, 30), (age/field, younger than, 30/value) conforms to the predefined rule in a query statement or a sequence, and a complete query condition is (age, <, 30). For a finally output query target—post name, query conditions are (time of graduation, =, 2013), (school of graduation, =, Peking University), (age, <, 30), (job level, =, level 18), and (department, =, department in which the user works).

213. Generate a database query statement.

Specifically, the database query statement, for example, SQL, is generated according to the query condition and target that are output by the foregoing module. For the current query statement, a generated database query statement is: select a post name from view where time of graduation=2013 and school of graduation=Peking University and age<30 and job level=18 and department=department in which the user works, and a database is retrieved.

214. Output a result.

Specifically, the database query statement is executed, and a retrieval result is returned to the user.

According to this embodiment of the present invention, a query target and a query condition are generated for a to-be-queried statement that is a natural language query statement, and query is performed according to the query target and the query condition, so as to obtain a query result. In this way, a database can be queried according to a user request. According to this embodiment of the present invention, a user does not need to be familiar with database query language, which improves user experience.

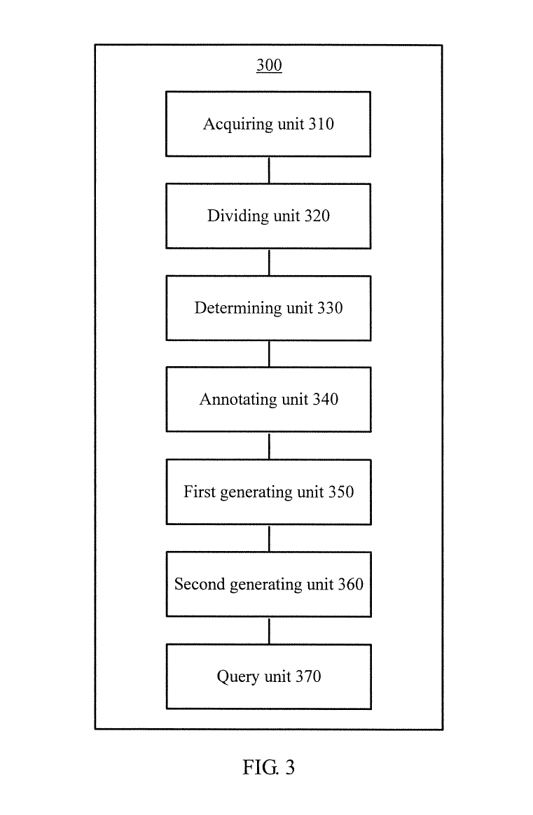

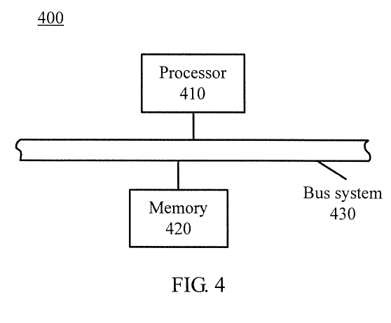

The database query method according to the embodiments of the present invention is described in the foregoing in detail with reference to FIG. 1 to FIG. 2. A database query device according to the embodiments of the present invention is described in the following in detail with reference to FIG. 3 to FIG. 4.

FIG. 3 is a schematic block diagram of a database query device according to an embodiment of the present invention. The database query device may be user equipment, a database server, or the like. A device 300 shown in FIG. 3 includes: an acquiring unit 310, a dividing unit 320, a determining unit 330, an annotating unit 340, a first generating unit 350, a second generating unit 360, and a query unit 370.

Specifically, the acquiring unit 310 is configured to acquire a to-be-queried statement, where the to-be-queried statement is a natural language query statement; the dividing unit 320 is configured to divide the to-be-queried statement according to a preset word stock to obtain N words; the determining unit 330 is configured to determine, from a preset database, at least one candidate database entity of a first word, where the first word is any word in the N words; the annotating unit 340 is configured to separately annotate a label on each word in the N words to obtain annotation information corresponding to the to-be-queried statement, where the annotation information includes the N words and a label one-to-one corresponding to each word in the N words, a label one-to-one corresponding to the first word is used to indicate a data type of the first word, and the label of the first word includes an attribute name or an attribute value; the first generating unit 350 is configured to generate K query conditions according to the annotation information, where each query condition in the K query conditions includes a second word, an operator, and a third word, the operator indicates a relationship between the second word and the third word, a label of the second word is an attribute name, and a label of the third word is an attribute value; the second generating unit 360 is configured to generate a query target according to the annotation information, where the query target includes a database entity of at least one word in the N words, a label of the at least one word is an attribute name, and a database entity of each word in the at least one word is one of at least one candidate database entity of each word; and the query unit 370 is configured to perform query according to the K query conditions and the query target to obtain a query result.

According to this embodiment of the present invention, a query target and a query condition are generated for a to-be-queried statement that is a natural language query statement, and query is performed according to the query target and the query condition, so as to obtain a query result. In this way, a database can be queried according to a user request. According to this embodiment of the present invention, a user does not need to be familiar with database query language, which improves user experience.

Optionally, as another embodiment, the dividing unit 320 divides the to-be-queried statement according to the preset word stock to obtain N initial words; and standardizes the N initial words according to a preset rule to obtain the N words.

Optionally, as another embodiment, the determining unit 330 determines, from the preset database, n initial candidate database entities of the first word, where n is an integer greater than or equal to 1; and when n is greater than 1, determines relevancy between each initial candidate database entity in the n initial candidate database entities and the first word, and determines an initial candidate database entity, relevancy between which and the first word is greater than a preset threshold, in the n initial candidate database entities as the at least one candidate database entity of the first word; or when n is equal to 1, determines the n initial candidate database entities of the first word as the at least one candidate database entity of the first word.

Further, as another embodiment, the determining unit 330 determines the relevancy between each initial candidate database entity in the n initial candidate database entities and the first word according to at least one of the following methods: a hit rate, vector space cosine, and an edit distance.

Optionally, as another embodiment, the device 300 further includes a combining unit. Specifically, the combining unit is configured to: before the first generating unit 350 generates the K query conditions according to the annotation information, combine, according to a candidate database entity of a word in the annotation information, words successively labeled as an attribute name in the annotation information, so as to obtain a first combined word, where the first combined word is an intersection set of candidate database entities of the words successively labeled as an attribute name in the annotation information; and use the first combined word to replace the words successively labeled as an attribute name in the annotation information, so as to update the annotation information; and/or combine, according to a candidate database entity of a word in the annotation information, words successively labeled as an attribute value in the annotation information, so as to obtain a second combined word, where the second combined word is an intersection set of candidate database entities of the words successively labeled as an attribute value in the annotation information; and use the second combined word to replace the words successively labeled as an attribute value in the annotation information, so as to update the annotation information; where the first generating unit 350 generates the K query conditions according to updated annotation information, and the second generating unit 360 generates the query target according to the updated annotation information.

Optionally, as another embodiment, the first generating unit 350 generates M candidate query conditions according to the annotation information, where each candidate query condition in the M candidate query conditions includes a correspondence among a first candidate word, an operator, and a second candidate word, a label of the first candidate word is an attribute name, and a label of the second candidate word is an attribute value; determines a matching index between the first candidate word and the second candidate word of each candidate query condition; and determines K candidate query conditions that are in the M candidate query conditions and whose matching index is greater than a preset threshold as the K query conditions.

Further, as another embodiment, the first generating unit 350 generates M initial candidate query conditions according to the annotation information; and performs disambiguation processing on the M initial candidate query conditions according to user information to obtain the M candidate query conditions, where the disambiguation processing includes: removing, according to the user information, ambiguity of an initial candidate query condition in which the ambiguity exists in the M initial candidate query conditions, and the user information includes at least one of: hardware information of a terminal device, software information of a terminal system, user data stored in a memory or a storage device of a terminal, a historical operation of a user, and setting of the user.

Further, as another embodiment, the first generating unit 350 determines the matching index according to at least one of: a pairing probability, a sequence distance, a matching degree of a database data type, and a language habit constraint of the first candidate word and the second candidate word.

Specifically, as another embodiment, the pairing probability is determined by an intersection set of a database entity corresponding to the first candidate word and a database entity corresponding to the second candidate word, and a smaller intersection set of the database entity corresponding to the first candidate word and the database entity corresponding to the second candidate word indicates a larger pairing probability and a larger matching index.

Specifically, as another embodiment, the sequence distance is determined by a distance between the first candidate word and the second candidate word in the annotation information or the query statement, a larger distance between the first candidate word and the second candidate word in the annotation information or the query statement indicates a larger sequence distance and a smaller matching index, and a quantity of words between the first candidate word and the second candidate word in the annotation information or the query statement indicates a length of the distance.

Specifically, as another embodiment, the matching degree of the database data type is determined according to whether a database data type of the first candidate word is consistent with that of the second candidate word, a matching degree of a database data type when the database data type of the first candidate word is consistent with that of the second candidate word is greater than a matching degree of a database data type when the database data type of the first candidate word is inconsistent with that of the second candidate word, and the matching index is positively correlated with the matching degree of the database data type.

Specifically, as another embodiment, the language habit constraint is determined according to whether the first candidate word and the second candidate word conform to a database or a language habit, a language habit constraint when the first candidate word and the second candidate word conform to the database or the language habit is less than a language habit constraint when the first candidate word and the second candidate word do not conform to the database or the language habit, and the matching index is negatively correlated with the language habit constraint.

Specifically, as another embodiment, the second generating unit 360 determines that a word whose label in the annotation information is an attribute name satisfies a preset condition and/or is an acnodal word, where the acnodal word has no corresponding word whose label is an attribute value; and uses the attribute name of the word whose label in the annotation information is the attribute name as the query target.

It should be noted that the database query device shown in FIG. 3 can implement all processes that are completed by the database query device in the method embodiments shown in FIG. 1 to FIG. 2. For other functions and operations of the database query device 300, reference may be made to all the processes of the database query device that are involved in the method embodiments shown in FIG. 1 and FIG. 2. To avoid redundancy, details are not described herein again.

FIG. 4 is a schematic block diagram of a database query device according to another embodiment of the present invention. A device 400 shown in FIG. 4 includes: a processor 410, a memory 420, and a bus system 430.

Specifically, the processor 410 invokes, by using the bus system 430, code stored in the memory 420 to: acquire a to-be-queried statement, where the to-be-queried statement is a natural language query statement; divide the to-be-queried statement according to a preset word stock to obtain N words; determine, from a preset database, at least one candidate database entity of a first word, where the first word is any word in the N words; separately annotate a label on each word in the N words to obtain annotation information corresponding to the to-be-queried statement, where the annotation information includes the N words and a label one-to-one corresponding to each word in the N words, a label one-to-one corresponding to the first word is used to indicate a data type of the first word, and the label of the first word includes an attribute name or an attribute value; generate K query conditions according to the annotation information, where each query condition in the K query conditions includes a second word, an operator, and a third word, the operator indicates a relationship between the second word and the third word, a label of the second word is an attribute name, and a label of the third word is an attribute value; generate a query target according to the annotation information, where the query target includes a database entity of at least one word in the N words, a label of the at least one word is an attribute name, and a database entity of each word in the at least one word is one of at least one candidate database entity of each word; and perform query according to the K query conditions and the query target to obtain a query result.

According to this embodiment of the present invention, a query target and a query condition are generated for a to-be-queried statement that is a natural language query statement, and query is performed according to the query target and the query condition, so as to obtain a query result. In this way, a database can be queried according to a user request. According to this embodiment of the present invention, a user does not need to be familiar with database query language, which improves user experience.

The method disclosed in the foregoing embodiment of the present invention may be applied to the processor 410, or is implemented by the processor 410. The processor 410 may be an integrated circuit chip and has a signal processing capability. In an implementation process, each step of the foregoing method may be completed by means of an integrated logic circuit of hardware in the processor 410 or an instruction in a software form. The foregoing processor 410 may be a general purpose processor, a digital signal processor (DSP), an application-specific integrated circuit (ASIC), a field programmable gate array (FPGA), or another programmable logical device, discrete gate or transistor logical device, or discrete hardware component. The processor 410 may implement or execute methods, steps and logical block diagrams disclosed in the embodiments of the present invention. A general purpose processor may be a microprocessor or the processor may be any conventional processor or the like. Steps of the methods disclosed with reference to the embodiments of the present invention may be directly executed and completed by means of a hardware decoding processor, or may be executed and completed by using a combination of hardware and software modules in a decoding processor. A software module may be located in a mature storage medium in the art, such as a random access memory (RAM), a flash memory, a read-only memory (ROM), a programmable read-only memory, an electrically-erasable programmable memory, or a register. The storage medium is located in the memory 420, and the processor 410 reads information in the memory 420 and completes steps of the foregoing method with reference to hardware of the processor 410. The bus system 430 may further include a power bus, a control bus, a status signal bus, and the like, in addition to a data bus.

However, for clear description, various types of buses in the figure are marked as the bus system 430.

Optionally, as another embodiment, the processor 410 divides the to-be-queried statement according to the preset word stock to obtain N initial words; and standardizes the N initial words according to a preset rule to obtain the N words.

Optionally, as another embodiment, the processor 410 determines, from the preset database, n initial candidate database entities of the first word, where n is an integer greater than or equal to 1; and when n is greater than 1, determines relevancy between each initial candidate database entity in the n initial candidate database entities and the first word, and determines an initial candidate database entity, relevancy between which and the first word is greater than a preset threshold, in the n initial candidate database entities as the at least one candidate database entity of the first word; or when n is equal to 1, determines the n initial candidate database entities of the first word as the at least one candidate database entity of the first word.

Further, as another embodiment, the processor 410 determines the relevancy between each initial candidate database entity in the n initial candidate database entities and the first word according to at least one of the following methods: a hit rate, vector space cosine, and an edit distance.

Optionally, as another embodiment, before the K query conditions are generated according to the annotation information, the processor 410 combines, according to a candidate database entity of a word in the annotation information, words successively labeled as an attribute name in the annotation information, so as to obtain a first combined word, where the first combined word is an intersection set of candidate database entities of the words successively labeled as an attribute name in the annotation information; and uses the first combined word to replace the words successively labeled as an attribute name in the annotation information, so as to update the annotation information; and/or combines, according to a candidate database entity of a word in the annotation information, words successively labeled as an attribute value in the annotation information, so as to obtain a second combined word, where the second combined word is an intersection set of candidate database entities of the words successively labeled as an attribute value in the annotation information; and uses the second combined word to replace the words successively labeled as an attribute value in the annotation information, so as to update the annotation information; where that the processor 410 generates the K query conditions according to updated annotation information, and generates the query target according to the updated annotation information.

Optionally, as another embodiment, the processor 410 generates M candidate query conditions according to the annotation information, where each candidate query condition in the M candidate query conditions includes a correspondence among a first candidate word, an operator, and a second candidate word, a label of the first candidate word is an attribute name, and a label of the second candidate word is an attribute value; determines a matching index between the first candidate word and the second candidate word of each candidate query condition; and determines K candidate query conditions that are in the M candidate query conditions and whose matching index is greater than a preset threshold as the K query conditions.

Further, as another embodiment, the processor 410 generates M initial candidate query conditions according to the annotation information; and performs disambiguation processing on the M initial candidate query conditions according to user information to obtain the M candidate query conditions, where the disambiguation processing includes: removing, according to the user information, ambiguity of an initial candidate query condition in which the ambiguity exists in the M initial candidate query conditions, and the user information includes at least one of: hardware information of a terminal device, software information of a terminal system, user data stored in a memory or a storage device of a terminal, a historical operation of a user, and setting of the user.

Further, as another embodiment, the processor 410 determines the matching index according to at least one of: a pairing probability, a sequence distance, a matching degree of a database data type, and a language habit constraint of the first candidate word and the second candidate word.

Specifically, as another embodiment, the pairing probability is determined by an intersection set of a database entity corresponding to the first candidate word and a database entity corresponding to the second candidate word, and a smaller intersection set of the database entity corresponding to the first candidate word and the database entity corresponding to the second candidate word indicates a larger pairing probability and a larger matching index.

Specifically, as another embodiment, the sequence distance is determined by a distance between the first candidate word and the second candidate word in the annotation information or the query statement, a larger distance between the first candidate word and the second candidate word in the annotation information or the query statement indicates a larger sequence distance and a smaller matching index, and a quantity of words between the first candidate word and the second candidate word in the annotation information or the query statement indicates a length of the distance.

Specifically, as another embodiment, the matching degree of the database data type is determined according to whether a database data type of the first candidate word is consistent with that of the second candidate word, a matching degree of a database data type when the database data type of the first candidate word is consistent with that of the second candidate word is greater than a matching degree of a database data type when the database data type of the first candidate word is inconsistent with that of the second candidate word, and the matching index is positively correlated with the matching degree of the database data type.

Specifically, as another embodiment, the language habit constraint is determined according to whether the first candidate word and the second candidate word conform to a database or a language habit, a language habit constraint when the first candidate word and the second candidate word conform to the database or the language habit is less than a language habit constraint when the first candidate word and the second candidate word do not conform to the database or the language habit, and the matching index is negatively correlated with the language habit constraint.

Specifically, as another embodiment, the processor 410 determines that a word whose label in the annotation information is an attribute name satisfies a preset condition and/or is an acnodal word, where the acnodal word has no corresponding word whose label is an attribute value; and uses the attribute name of the word whose label in the annotation information is the attribute name as the query target.

It should be noted that the database query device 400 shown in FIG. 4 corresponds to the database query device 300 shown in FIG. 3, and can implement all processes that are completed by the database query device in the method embodiments shown in FIG. 1 to FIG. 2. For other functions and operations of the database query device 400, reference may be made to all the processes of the database query device that are involved in the method embodiments shown in FIG. 1 and FIG. 2. To avoid redundancy, details are not described herein again.

It should be understood that “one embodiment” or “an embodiment” mentioned in the specification means that specific characteristics, structures, or features that are related to embodiments are included in at least one embodiment of the present invention. Therefore, “in one embodiment” or “in an embodiment” appearing in the specification does not necessarily refer to a same embodiment. In addition, these specific characteristics, structures, or features may be integrated in one or more embodiments in any proper manner. It should be understood that sequence numbers of the foregoing processes do not mean execution sequences in various embodiments of the present invention. The execution sequences of the processes should be determined according to functions and internal logic of the processes, and should not be construed as any limitation on the implementation processes of the embodiments of the present invention.

In addition, the terms “system” and “network” may be used interchangeably in this specification. The term “and/or” in this specification describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

It should be understood that in the embodiments of the present invention, “B corresponding to A” indicates that B is associated with A, and B may be determined according to A. However, it should further be understood that determining B according to A does not mean that B is determined according to only A, and B may also be determined according to A and/or other information.

Persons of ordinary skill in the art may be aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solutions. Persons skilled in the art may use different methods to implement the described functions for each particular application, but it should not be considered that such implementation goes beyond the scope of the present invention.

It may be clearly understood by persons skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the foregoing described apparatus embodiment is merely exemplary. For example, the unit division is merely logical function division and may be other division in actual implementation. For example, multiple units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on multiple network units . Some or all of the units may be selected according to actual requirements to achieve the objectives of the solutions of the embodiments of the present invention.

In addition, functional units in the embodiments of the present invention may be integrated into one processing unit, or each of the units may exist alone physically, or two or more units are integrated into one unit. The foregoing integrated unit may be implemented in a form of hardware, or may be implemented in a form of a software functional unit.

With descriptions of the foregoing embodiments, persons skilled in the art may clearly understand that the present invention may be implemented by hardware, firmware or a combination thereof. When the present invention is implemented by software, the foregoing functions may be stored in a computer-readable medium or transmitted as one or more instructions or code in the computer-readable medium. The computer-readable medium includes a computer storage medium and a communications medium, where the communications medium includes any medium that enables a computer program to be transmitted from one place to another. The storage medium may be any available medium accessible by a computer. The following provides an example but does not impose a limitation: The computer-readable medium may include a RAM, a ROM, an EEPROM, a CD-ROM, or another optical disc storage or disk storage medium, or another magnetic storage device, or any other medium that can carry or store expected program code in a form of an instruction or a data structure and can be accessed by a computer. In addition, any connection may be appropriately defined as a computer-readable medium. For example, if software is transmitted from a website, a server or another remote source by using a coaxial cable, an optical fiber/cable, a twisted pair, a digital subscriber line (DSL) or wireless technologies such as infrared ray, radio and microwave, the coaxial cable, optical fiber/cable, twisted pair, DSL or wireless technologies such as infrared ray, radio and microwave are included in a definition of a medium to which they belong. For example, a disk (Disk) and disc (disc) used by the present invention includes a compact disc (CD), a laser disc, an optical disc, a digital versatile disc (DVD), a floppy disk and a Blu-ray disc, where the disk generally copies data by a magnetic means, and the disc copies data optically by a laser means. The foregoing combination should also be included in the protection scope of the computer-readable medium.

In summary, the foregoing descriptions are merely exemplary embodiments of the technical solutions of the present invention, but are not intended to limit the protection scope of the present invention. Any modification, equivalent replacement, or improvement made without departing from the spirit and principle of the present invention shall fall within the protection scope of the present invention.

What is claimed is:

1. A database query method, comprising:
acquiring a to-be-queried statement, wherein the to-be-queried statement is a natural language query statement;
dividing the to-be-queried statement according to a preset word stock to obtain N words, wherein N is an integer greater than or equal to 1;
determining, from a preset database, at least one candidate database entity of a first word, wherein the first word is any word in the N words;
separately annotating a label on each word in the N words to obtain annotation information corresponding to the to-be-queried statement, wherein the annotation information comprises the N words and a label one-to-one corresponding to each word in the N words, a label one-to-one corresponding to the first word is used to indicate a data type of the first word, and the label of the first word comprises an attribute name or an attribute value;
generating K query conditions according to the annotation information, wherein each query condition in the K query conditions comprises a second word, an operator, and a third word, the operator indicates a relationship between the second word and the third word, a label of the second word is an attribute name, a label of the third word is an attribute value, and K is an integer greater than or equal to 1 and less than N;
generating a query target according to the annotation information, wherein the query target comprises a database entity of at least one word in the N words, a label of the at least one word is an attribute name, and a database entity of each word in the at least one word is one of at least one candidate database entity of each word; and
performing a query according to the K query conditions and the query target to obtain a query result.

2. The method according to claim 1, wherein dividing the to-be-queried statement according to a preset word stock to obtain N words comprises:
dividing the to-be-queried statement according to the preset word stock to obtain N initial words; and
standardizing the N initial words according to a preset rule to obtain the N words.

3. The method according to claim 1, wherein determining, from a preset database, at least one candidate database entity of a first word comprises:
determining, from the preset database, n initial candidate database entities of the first word, wherein n is an integer greater than or equal to 1; and
when n is greater than 1, determining relevancy between each initial candidate database entity in the n initial candidate database entities and the first word, and determining an initial candidate database entity, relevancy between which and the first word is greater than a preset threshold, in the n initial candidate database entities as the at least one candidate database entity of the first word; or
when n is equal to 1, determining the n initial candidate database entities of the first word as the at least one candidate database entity of the first word.

4. The method according to claim 3, wherein determining relevancy between each initial candidate database entity in the n initial candidate database entities and the first word comprises:
determining the relevancy between each initial candidate database entity in the n initial candidate database entities and the first word according to at least one of the following methods:
a hit rate, vector space cosine, and an edit distance.

5. The method according to claim 1, wherein:
before generating K query conditions according to the annotation information, the method further comprises:
combining, according to a candidate database entity of a word in the annotation information, words successively labeled as an attribute name in the annotation information, so as to obtain a first combined word, wherein the first combined word is an intersection set of candidate database entities of the words successively labeled as an attribute name in the annotation information; and using the first combined word to replace the words successively labeled as an attribute name in the annotation information, so as to update the annotation information, and/or
combining, according to a candidate database entity of a word in the annotation information, words successively labeled as an attribute value in the annotation information, so as to obtain a second combined word, wherein the second combined word is an intersection set of candidate database entities of the words successively labeled as an attribute value in the annotation information; and using the second combined word to replace the words successively labeled as an attribute value in the annotation information, so as to update the annotation information;
generating K query conditions according to the annotation information comprises:
generating the K query conditions according to updated annotation information; and
generating a query target according to the annotation information comprises:
generating the query target according to the updated annotation information.

6. The method according to claim 1, wherein generating K query conditions according to the annotation information comprises:
generating M candidate query conditions according to the annotation information, wherein each candidate query condition in the M candidate query conditions comprises a correspondence among a first candidate word, an operator, and a second candidate word, a label of the first candidate word is an attribute name, a label of the second candidate word is an attribute value, and M is an integer greater than or equal to K;
determining a matching index between the first candidate word and the second candidate word of each candidate query condition; and
determining K candidate query conditions that are in the M candidate query conditions and whose matching index is greater than a preset threshold as the K query conditions.

7. The method according to claim 6, wherein generating M candidate query conditions according to the annotation information comprises:
generating N initial candidate query conditions according to the annotation information; and
performing disambiguation processing on the M initial candidate query conditions according to user information to obtain the M candidate query conditions, wherein the disambiguation processing comprises:
removing, according to the user information, ambiguity of an initial candidate query condition in which the ambiguity exists in the M initial candidate query conditions, and the user information comprises at least one of: hardware information of a terminal device, software information of a terminal system, user data stored in a memory or a storage device of a terminal, a historical operation of a user, and setting of the user.

8. The method according to claim 6, wherein determining a matching index between the first candidate word and the second candidate word of each candidate query condition comprises:
determining the matching index according to at least one of: a pairing probability, a sequence distance, a matching degree of a database data type, and a language habit constraint of the first candidate word and the second candidate word.

9. The method according to claim 8, wherein the pairing probability is determined by an intersection set of a database entity corresponding to the first candidate word and a database entity corresponding to the second candidate word, and a smaller intersection set of the database entity corresponding to the first candidate word and the database entity corresponding to the second candidate word indicates a larger pairing probability and a larger matching index.

10. The method according to claim 8, wherein the sequence distance is determined by a distance between the first candidate word and the second candidate word in the annotation information or the query statement, a larger distance between the first candidate word and the second candidate word in the annotation information or the query statement indicates a larger sequence distance and a smaller matching index, and a quantity of words between the first candidate word and the second candidate word in the annotation information or the query statement indicates a length of the distance.

11. The method according to claim 8, wherein the matching degree of the database data type is determined according to whether a database data type of the first candidate word is consistent with that of the second candidate word, a matching degree of a database data type when the database data type of the first candidate word is consistent with that of the second candidate word is greater than a matching degree of a database data type when the database data type of the first candidate word is inconsistent with that of the second candidate word, and the matching index is positively correlated with the matching degree of the database data type.

12. The method according to claim 8, wherein the language habit constraint is determined according to whether the first candidate word and the second candidate word conform to a database or a language habit, a language habit constraint when the first candidate word and the second candidate word conform to the database or the language habit is less than a language habit constraint when the first candidate word and the second candidate word do not conform to the database or the language habit, and the matching index is negatively correlated with the language habit constraint.

13. The method according to claim 1, wherein generating a query target according to the annotation information comprises:
determining that a word whose label in the annotation information is an attribute name satisfies a preset condition and/or is an acnodal word, wherein the acnodal word has no corresponding word whose label is an attribute value; and
using the attribute name of the word whose label in the annotation information is the attribute name as the query target.

14. A database query device, comprising:
an acquiring unit, configured to acquire a to-be-queried statement, wherein the to-be-queried statement is a natural language query statement;
a dividing unit, configured to divide the to-be-queried statement according to a preset word stock to obtain N words, wherein N is an integer greater than or equal to 1;
a determining unit, configured to determine, from a preset database, at least one candidate database entity of a first word, wherein the first word is any word in the N words;
an annotating unit, configured to separately annotate a label on each word in the N words to obtain annotation information corresponding to the to-be-queried statement, wherein the annotation information comprises the N words and a label one-to-one corresponding to each word in the N words, a label one-to-one corresponding to the first word is used to indicate a data type of the first word, and the label of the first word comprises an attribute name or an attribute value;
a first generating unit, configured to generate K query conditions according to the annotation information, wherein each query condition in the K query conditions comprises a second word, an operator, and a third word, the operator indicates a relationship between the second word and the third word, a label of the second word is an attribute name, a label of the third word is an attribute value, and K is an integer greater than or equal to 1 and less than N;
a second generating unit, configured to generate a query target according to the annotation information, wherein the query target comprises a database entity of at least one word in the N words, a label of the at least one word is an attribute name, and a database entity of each word in the at least one word is one of at least one candidate database entity of each word; and
a query unit, configured to perform a query according to the K query conditions and the query target to obtain a query result.

15. The device according to claim 14, wherein the dividing unit is configured to:
divide the to-be-queried statement according to the preset word stock to obtain N initial words; and
standardize the N initial words according to a preset rule to obtain the N words.

16. The device according to claim 14, wherein the determining unit is configured to:
determine, from the preset database, n initial candidate database entities of the first word, wherein n is an integer greater than or equal to 1; and
when n is greater than 1, determine relevancy between each initial candidate database entity in the n initial candidate database entities and the first word, and determine an initial candidate database entity, relevancy between which and the first word is greater than a preset threshold, in the n initial candidate database entities as the at least one candidate database entity of the first word; or
when n is equal to 1, determine the n initial candidate database entities of the first word as the at least one candidate database entity of the first word.

17. The device according to claim 16, wherein the determining unit is configured to:
determine the relevancy between each initial candidate database entity in the n initial candidate database entities and the first word according to at least one of the following methods: a hit rate, vector space cosine, and an edit distance.

18. The device according to claim 14, further comprising:
a combining unit, configured to:
before the first generating unit generates the K query conditions according to the annotation information, combine, according to a candidate database entity of a word in the annotation information, words successively labeled as an attribute name in the annotation information, so as to obtain a first combined word, wherein the first combined word is an intersection set of candidate database entities of the words successively labeled as an attribute name in the annotation information,
use the first combined word to replace the words successively labeled as an attribute name in the annotation information, so as to update the annotation information, and/or
combine, according to a candidate database entity of a word in the annotation information, words successively labeled as an attribute value in the annotation information, so as to obtain a second combined word, wherein the second combined word is an intersection set of candidate database entities of the words successively labeled as an attribute value in the annotation information, and
use the second combined word to replace the words successively labeled as an attribute value in the annotation information, so as to update the annotation information;
wherein the first generating unit is configured to: generate the K query conditions according to updated annotation information; and
wherein the second generating unit is configured to: generate the query target according to the updated annotation information.

19. The device according to claim 14, wherein the first generating unit is configured to:
generate M candidate query conditions according to the annotation information, wherein each candidate query condition in the M candidate query conditions comprises a correspondence among a first candidate word, an operator, and a second candidate word, a label of the first candidate word is an attribute name, a label of the second candidate word is an attribute value, and M is an integer greater than or equal to K;
determine a matching index between the first candidate word and the second candidate word of each candidate query condition; and
determine K candidate query conditions that are in the M candidate query conditions and whose matching index is greater than a preset threshold as the K query conditions.

20. The device according to claim 19, wherein the first generating unit is configured to:
generate M initial candidate query conditions according to the annotation information; and
perform disambiguation processing on the M initial candidate query conditions according to user information to obtain the M candidate query conditions, wherein the disambiguation processing comprises:
removing, according to the user information, ambiguity of an initial candidate query condition in which the ambiguity exists in the M initial candidate query conditions, and the user information comprises at least one of: hardware information of a terminal device, software information of a terminal system, user data stored in a memory or a storage device of a terminal,
a historical operation of a user, and setting of the user.

21. The device according to claim 19, wherein the first generating unit is configured to:
determine the matching index according to at least one of: a pairing probability, a sequence distance, a matching degree of a database data type, and a language habit constraint of the first candidate word and the second candidate word.

22. The device according to claim 21, wherein the pairing probability is determined by an intersection set of a database entity corresponding to the first candidate word and a database entity corresponding to the second candidate word, and a smaller intersection set of the database entity corresponding to the first candidate word and the database entity corresponding to the second candidate word indicates a larger pairing probability and a larger matching index.

23. The device according to claim 21, wherein the sequence distance is determined by a distance between the first candidate word and the second candidate word in the annotation information or the query statement, a larger distance between the first candidate word and the second candidate word in the annotation information or the query statement indicates a larger sequence distance and a smaller matching index, and a quantity of words between the first candidate word and the second candidate word in the annotation information or the query statement indicates a length of the distance.

24. The device according to claim 21, wherein the matching degree of the database data type is determined according to whether a database data type of the first candidate word is consistent with that of the second candidate word, a matching degree of a database data type when the database data type of the first candidate word is consistent with that of the second candidate word is greater than a matching degree of a database data type when the database data type of the first candidate word is inconsistent with that of the second candidate word, and the matching index is positively correlated with the matching degree of the database data type.

25. The device according to claim 21, wherein the language habit constraint is determined according to whether the first candidate word and the second candidate word conform to a database or a language habit, a language habit constraint when the first candidate word and the second candidate word conform to the database or the language habit is less than a language habit constraint when the first candidate word and the second candidate word do not conform to the database or the language habit, and the matching index is negatively correlated with the language habit constraint.

26. The device according to claim 14, wherein the second generating unit is configured to:
determine that a word whose label in the annotation information is an attribute name satisfies a preset condition and/or is an acnodal word, wherein the acnodal word has no corresponding word whose label is an attribute value; and
use the attribute name of the word whose label in the annotation information is the attribute name as the query target.
